(19) United States
(12) Patent Application Publication
(10) Pub. No.: US 2003/0110392 A1
(43) Pub. Date: Jun. 12, 2003

(54) Detecting intrusions

(76) Inventors: David W. Aucsmith, Portland, OR (US); John W. Richardson, Portland, OR (US)

Correspondence Address: FISH & RICHARDSON, PC, 4350 LA JOLLA VILLAGE DRIVE, SUITE 500, SAN DIEGO, CA, 92122, US

(21) Appl. No.: 10/010,743

(22) Filed: Dec. 6, 2001

(51) Int. Cl. H04L 9/00

(52) U.S. Cl. 713/200

(57) ABSTRACT

Detecting intrusions includes detecting a possible security problem at a client location, transmitting notice of the possible security problem across a network in real time to a home location remotely located from the client location, determining at the home location an anomaly based on at least the possible security problem, and transmitting notice of the anomaly in real time to the client location.

### BACKGROUND

This invention relates to detecting intrusions.

An entity may make resources such as applications, collections of data, programs, and other similar resources available over a network. Security measures may exist to protect the resources against unauthorized network access, but illicit attempts to access the resources may still be made. The entity may set up an intrusion detection system to help discover such attempts and actual security breaches.

Generally, an intrusion detection system gathers information flowing between the network and the entity providing the resources and analyzes the information for possible security problems. Such analysis can include evaluating compliance with system policies, detecting access to resources by parties having gained unauthorized or otherwise impermissible access to the resources from inside or outside the entity (e.g., by providing false identification information, by bypassing security measures such as firewalls and password checks, by hacking in to the entity, etc.), detecting the addition of malicious files (e.g., viruses, Trojan horses, etc.), evaluating typical access patterns for unusual activity, and performing other security-related operations.

### DESCRIPTION OF DRAWINGS

FIG. 1 is a block diagram of an embodiment of a network configuration.

FIG. 2 is a flowchart showing an embodiment of a process of detecting intrusions.

FIG. 3 is a block diagram of an embodiment of a client intrusion detection system.

FIG. 4 is a block diagram of an embodiment of another network configuration.

FIG. 5 is a block diagram of an embodiment of a server intrusion detection system.

FIG. 6 is a flowchart showing an embodiment of a process of adding an application.

### DESCRIPTION

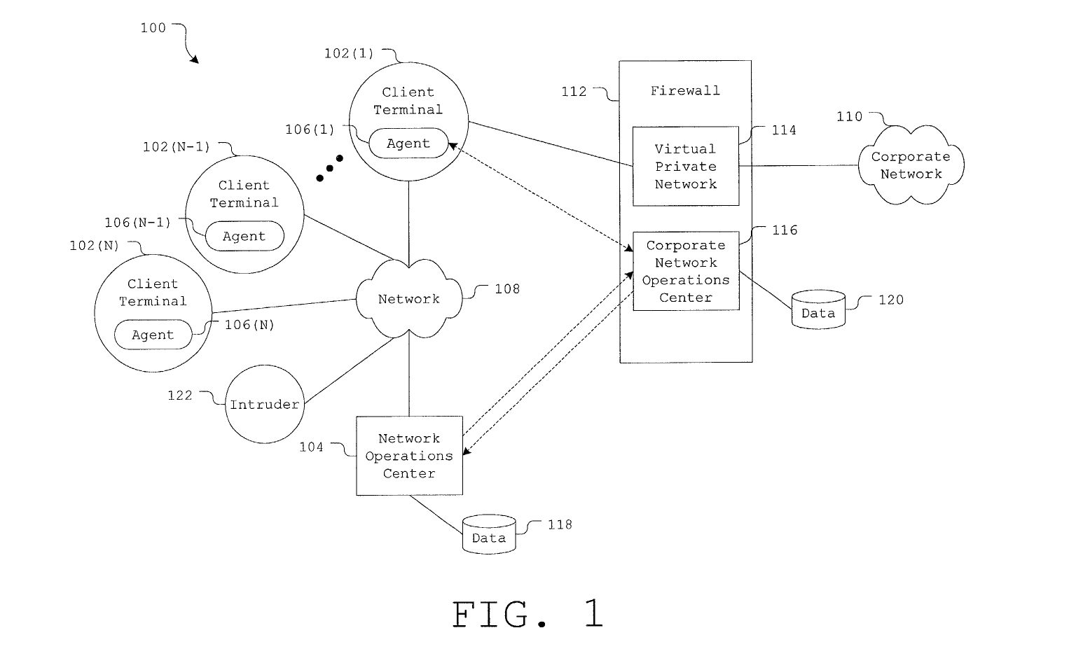

Referring to FIG. 1, an example network configuration 100 includes client terminals 102(1)-102(N) and a server 104 that can implement a real time intrusion detection system. (N represents a whole number.) The client terminals 102(1)-102(N) each include an agent 106(1)-106(N) that can monitor information received at its associated client terminal 102(1)-102(N) from a network 108, a corporate network 110, and/or other sources. If one of the agents 106(1)-106(N) detects a possible security problem in any of the information, the agent can report the possible security problem in real time to the server 104 through a firewall 112, a virtual private network (VPN) 114, and a corporate server 116. The security problem is labeled “possible” because the server 104 may determine it not to be a security problem.

The server 104 may then update its collection of security data 118 and the corporate server's collection of security data 120 to reflect this reported possible security problem. Additionally, the server 104 can in real time inform all of the client terminals 102(1)-102(N) of this possible security problem via each of the agents 106(1)-106(N).

In this way, the server 104 can propagate any possible security problems seen by any one of the client terminals 102(1)-102(N) to all of the client terminals 102(1)-102(N) so that all of the client terminals 102(1)-102(N) can defend against that possible security problem in real time (e.g., monitor for or prevent that security problem). Furthermore, with the server 104 able to receive security updates from multiple client terminals and to inform all (or at least a subset) of the client terminals 102(1)-102(N) in real time upon detection and/or correction of a security problem, any potentially negative effects of the security problem can be reduced or eliminated in real time.

The server 104 can also use the possible security problems reported by all of the agents 106(1)-106(N) to help detect intrusion patterns, new intrusion techniques, and other security problems that may not be apparent to an individual client terminal or to a small number of client terminals. The server 104 can inform all of the client terminals 102(1)-102(N) of such detected security issues in real time so that the client terminals 102(1)-102(N) may monitor information for those security issues.

“Real time” generally means continuous. Something occurring in real time can happen fast enough so the appropriate response occurs quickly, e.g., administrators at a server can address a security problem, clients may be notified of a security problem and/or modified to reduce or eliminate any potentially negative effects of a security problem, etc. Thus, while “real time” can mean instantaneously or within a fraction of a second, it could mean a longer time period, such as minutes, hours, days, etc., for less aggressive and/or slower systems or in instances of any kind of network delay.

Generally, a security problem involves an intrusion. The intrusion may come from a recognized party (e.g., one of the client terminals 102(1)-102(N)) or from an unrecognized, non-client third party (e.g., an intruder 122). Examples of security problems can include:

a) confidentiality, e.g., ensuring that only authorized parties can access resources available behind the firewall 112 (such as resources made available by the corporate network 110),

b) control and integrity, e.g., enabling only certain parties to access, edit, add, and/or delete resources available behind the firewall 112 and identifying non-standard network or resource access patterns,

c) authenticity, e.g., verifying the identity of parties, and/or

d) vulnerability, e.g., determining weaknesses in the security of the corporate network 110, the firewall 112, and the VPN 114.

It might be useful to detect security problems in the network configuration 100. The corporate network 110 may include a server that an organization associated with the corporate network 110 may want available over the VPN 114 to the client terminals 102(1)-102(N). These may include employees of the organization, customers of the organization, contractors of the organization, and other authorized parties. The organization may not, however, want any other parties to have access to the corporate network 110 or for the authorized parties to illicitly use or access restricted resources available in the corporate network 110. Thus, the organization may deploy an intrusion detection system including the server 104, the corporate server 116, and the agents 106(1)-106(N) at each of the client terminals 102(1)-102(N). The network configuration 100 may, of course, include additional security precautions.

Before further discussing detecting intrusions, the elements in the network configuration 100 are further described.

The elements in the network configuration 100 can be implemented in a variety of ways. Information communicated between elements included in the network configuration 100 can include data, instructions, or a combination of the two. The information may be in packets. Each sent packet may be part of a packet stream, where each of the packets included in the packet stream fits together to form a timewise contiguous stream of data. Information may be communicated between endpoints via multicast, unicast, or some combination of both.

The corporate network 110 and the network 108 can each include any kind and any combination of networks such as an Internet, a local area network (LAN) or other local network, a private network, a public network, or other similar network. Typically, the network 108 includes a public network while the corporate network 110 includes a private network. Communications through the corporate network 110 and the network 108 may be secured with a mechanism such as Transport Layer Security/Secure Socket Layer (TLS/SSL), wireless TLS (WTLS), or secure Hypertext Transfer Protocol (S-HTTP). Although discussed here as having a corporate association, the corporate network 110 can be associated with any type of organization: corporate, individual, non-profit, educational, etc.

The VPN 114 generally includes a private network existing within a public network. Information may be sent on the VPN 114 using public communication links (e.g., via the Internet), but the information may be protected with encryption and/or other security mechanisms so that only authorized users may access the information through the VPN 114.

The client terminals 102(1)-102(N) can each include any device capable of communicating with the network 108 and with the corporate network 110 through the VPN 114. Examples of such devices include a mobile computer, a stationary computer, a workstation, a server, a telephone, a pager, a personal digital assistant, and other similar devices. The intruder 122 may also include any of these example devices.

The agents 106(1)-106(N) can each include any mechanism capable of communicating with the corporate server 116 and executing an intrusion detection system on its associated client terminal. Examples of such agents include software programs or routines, applications, bots, and other similar mechanisms.

The server 104 can include any device capable of communicating with the network 108 and the corporate server 116 such as a file server, an application server, a mobile computer, a stationary computer, or other similar device. The server 104 may serve as a network operations center (NOC), a central network management server. Responsibilities of the server 104 may include setting policies regarding detection of possible security problems, monitoring general network issues, detecting intrusion patterns or new intrusion techniques, researching anomalies, receiving alerts from the corporate server 116, requesting a response to security updates from the corporate server 116 and/or the agents 106(1)-106(N), creating updates to transmit to the agents 106(1)-106(N), investigating possible security problems, resolving possible security problems, logging possible security problems received from the agents 106(1)-106(N), and performing other similar tasks.

The corporate server 116 can include any device capable of communicating with the server 104 and the agents 106(1)-106(N) such as a file server, an application server, a mobile computer, a stationary computer, or other similar device. The corporate server 116 may serve as an NOC for the corporate network 110. Responsibilities of the corporate server 116 may include setting policies regarding detection of possible security problems, monitoring general network issues, receiving alerts from the agents 106(1)-106(N), approving updates for the agents 106(1)-106(N) transmitted from the server 104, investigating possible security problems, and performing other similar tasks.

The collections of data 118 and 120 can each include a storage mechanism such as a data queue, a buffer, a local or remote memory device, a cache, or other similar storage mechanism. The collections of data 118 and 120 may be organized as databases. The collections of data 118 and 120 may be included in their respective servers 104 and 116 rather than exist as separate elements as shown in the network configuration 100.

The firewall 112 can include any hardware and/or software mechanism able to prevent unauthorized access to or from a network, such as between a private network (e.g., the corporate network 110) and a public network (e.g., the network 108).

Elements included in the network configuration 100 can communicate with other element(s) included in the network configuration 100 over one or more communication links. These communication links can include any kind and any combination of communication links such as modem links, Ethernet links, cables, point-to-point links, infrared connections, fiber optic links, wireless links, cellular links, Bluetooth, satellite links, and other similar links.

Elements included in the network configuration 100 may be remotely located from one another. That is, elements may be located in different geographical regions, may be physically separated by one or more communication links, may be included in different networks, and otherwise be separately located. For example, each of the client terminals 102(1)-102(N) may be located at different branch offices of an organization maintaining the corporate network 110 at a main branch office. The server 104 may be located at the main branch office or at another location, such as at a third party network maintenance site.

Furthermore, the network configuration 100 is simplified for ease of explanation. The network configuration 100 may include more or fewer additional elements such as networks, communication links, proxy servers, firewalls or other security mechanisms, Internet Service Providers (ISPs), gatekeepers, gateways, switches, routers, hubs, client terminals, and other elements.

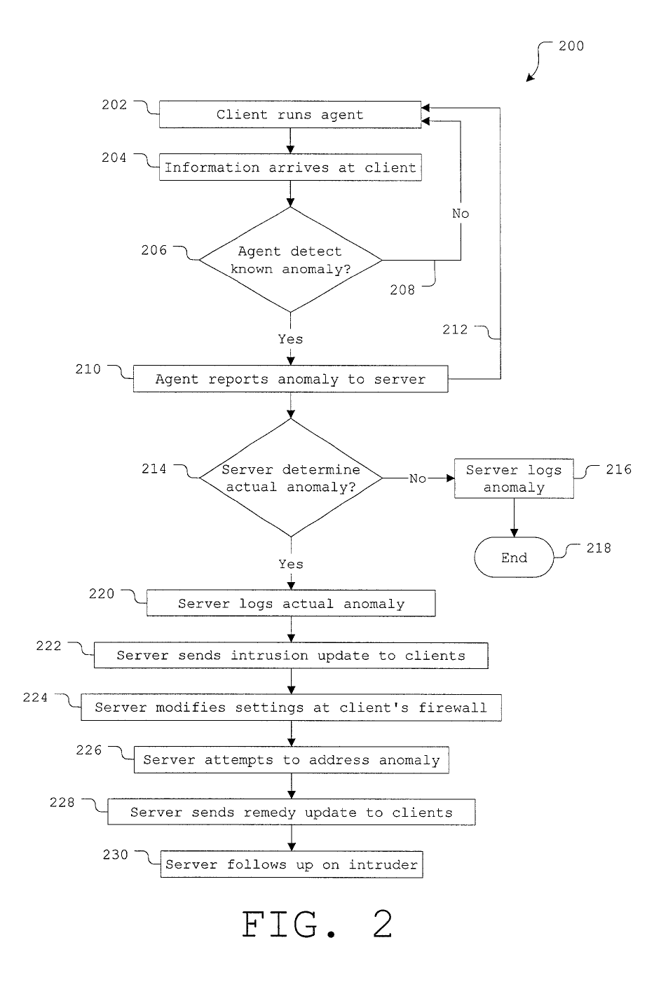

Referring to FIG. 2, a process 200 shows an example of detecting intrusions using the server 104, the corporate server 116, and the agents 106(1)-106(N) at each of the client terminals 102(1)-102(N). Although the process 200 is described with reference to the elements included in the network configuration 100 of FIG. 1, this or a similar process may be performed in another, similar network configuration.

In the process 200, the agents 106(1)-106(N) each run 202 on their associated client terminals 102(1)-102(N). For simplicity in this example, the client terminal 102(1) is referred to as “client 102” while its associated agent 106(1) is referred to as “agent 106.” The attributes of the client 102 and the agent 106 may similarly apply to the other client terminals and the other agents included in the network configuration 100.

The agent 106 typically waits (idles) on its associated client 102 until the occurrence of one or more events. In the process 200, the agent 106 waits until information arrives 204 at the client 102. The information typically arrives at the client 102 through the VPN 114, the corporate network 110, or the network 108 from one of the other client terminals or from another terminal capable of communicating through the VPN 114, the corporate network 110, or the network 108.

When information arrives at the client 102, the agent 106 examines the information and determines 206 if the information includes or indicates a known anomaly. Known anomalies include security problems that the server 104 has identified to the agent 106 and/or security problems that the agent 106 was initially configured to identify (and that have not since been deleted as anomalies to identify). The agent 106 may make this determination in real time.

In identifying known anomalies, the agent 106 may compare the information with information included in a collection of anomalies data included as part of the agent 106, in a collection of anomalies data included in the client 102 or otherwise accessible to the agent 106, in the corporate collection of security data 120, or in another similar resource.

For example, a packet may arrive at the client 102. The agent 106 may compare a source Internet Protocol (IP) address included in or with the packet with IP addresses of known intruders included in the corporate collection of security data 120. In another example when a packet arrives at the client 102, the agent 106 may examine the packet for particular queries or commands that fit an intrusion pattern or technique identified in the corporate collection of security data 120.

If the agent 106 does not detect a known anomaly, then the agent 102 returns 208 to waiting for another piece of information to arrive at the client 102 or to examining a piece of information that already arrived at the client 102. The client 102 may also process the information as appropriate because the information does not present a known security problem.

If the agent 106 does detect a known anomaly, then the agent 106 can report 210 the anomaly to the server 104. The agent 106 may report the anomaly in real time. The agent 106 may report the anomaly directly to the server 104 or to the server 104 through a network such as the VPN 114. The agent 106 may not report the anomaly to the server 104 or even know that notice of the anomaly will reach the server 104 but rather report the anomaly to an intermediary, such as to the corporate server 116 via the VPN 114. In this particular example, assume that the agent 106 transmits notice of the anomaly to the server 104 via the VPN 114 and the corporate server 116.

Once the agent 106 reports the anomaly, the agent 106 returns 212 to waiting for another piece of information to arrive at the client 102 or to examining a piece of information that previously arrived at the client 102.

The server 104 receives notice of the anomaly and can examine the anomaly to determine 214 if the anomaly constitutes an actual anomaly, e.g., a known security problem, a possible security problem serious enough to report to the client terminals 102(1)-102(N), etc. The server 104 may make such a determination in real time.

The server 104 may individually examine the anomaly or the server 104 may examine the anomaly in conjunction with other information accessible by the server 104, e.g., information included in the collection of security data 118, information sent to the server 104 from other sources, information accessible to the server 104 through the network 108 and/or the corporate server 116, and other similar types of information. The server 104 may examine the anomaly in any number of ways and may examine all anomalies in the same way or limit particular examinations to particular types of anomalies.

In individually examining the anomaly, the server 104 may, for example, search for particular information in the anomaly such as a network address previously noted as a security problem, a particular query or command associated with a known intrusion pattern or technique, a particular file name or file type associated with a known intrusion pattern or technique, and other similar types of information. In another example, the server 104 may check the identity of the sender of the information that triggered the agent 106 to report the anomaly.

In examining the anomaly in conjunction with other information, the server 104 may, for example, compare the anomaly with information previously logged at the server 104, perhaps in the collection of security data 118. For instance, the server 104 may look for non-standard access patterns, such as logins at unexpected hours or from unexpected locations or users.

If after whatever examination or examinations the server 104 performs on the anomaly the server 104 determines that the anomaly is not an actual anomaly, then the server 104 can log 216 the anomaly, e.g., in the collection of security data 118, for record-keeping purposes and/or to use in examining subsequently reported anomalies. The process then ends 218. The server 104 can, of course, continue examining other anomalies and continue performing any of its other duties.

If, however, the server 104 determines that the anomaly is an actual anomaly, then the server 104 may document the anomaly and/or perform or instigate corrective procedures to address the anomaly. The server 104 may perform such documentation and instigation automatically in real time upon recognition of the security problem. The server 104 may, however, delay such documentation and/or instigation until an administrator reviews the anomaly and/or any corrective procedures recommended by the server 104. The server 104 also may delegate the documentation and/or instigation to another mechanism, such as the corporate server 116.

In documenting the anomaly, the server 104 can log 220 the anomaly. Generally, logging the anomaly includes storing a record of the anomaly in the collection of security data 118. Information logged about an anomaly can include which of the client terminals 102(1)-102(N) reported the anomaly to the server 104, the time that the anomaly was sent to and/or received by the server 104, the nature of the anomaly, and/or other similar types of information.

Once logged, the server 104 may use the information about the anomaly along with other security problem information in performing general intrusion detection actions. Such actions can include monitoring and analyzing client and system activity (including examination of other anomalies sent to the server 104), performing audits, inspecting all incoming and outgoing information (e.g., packets), assessing integrity, recognizing attack patterns, reporting possible intrusions, and performing other similar tasks.

The server 104 can notify 222 the client terminals 102(1)-102(N) of the anomaly. The server 104 may send this notification in real time. The server 104 typically notifies the client terminals 102(1)-102(N) via the VPN 114. The server 104 may only notify the client 102, but typically notifies all of the client terminals 102(1)-102(N).

The notification to the client terminals 102(1)-102(N) can include the server 104 alerting the agents 106(1)-106(N) of the anomaly. In this way, the agents 106(1)-106(N) can all receive real time notification of the anomaly, immediately being able to check for that anomaly in examining information arriving at its respective client terminals 102(1)-102(N).

The notification may also include the server 104 notifying the client terminals 102(1)-102(N) with a message or other alert. For example, the server 104 may send a message to the client terminals 102(1)-102(N) via electronic mail, pager, or other similar mechanism, cause a visual and/or audio notice to appear at the client terminals 102(1)-102(N), and/or take other similar actions.

In addition to or instead of notifying the client terminals 102(1)-102(N) of the anomaly, the server 104 may notify 224 the firewall 112 of the anomaly. The server 104 may send this notification in real time. This notification may include updating the collection of corporate security data 120 to include information about the anomaly, modifying security procedures to account for the anomaly, or performing other similar tasks.

The server 104 may report the anomaly to the appropriate element or elements included in the network configuration 100 in real time and subsequently determine if the anomaly constitutes an actual security problem. In that case, the server 104 may needlessly report an anomaly if the anomaly turns out to not constitute an actual security problem. If, however, the implications of the anomaly are sufficiently severe, then reporting the anomaly as soon as possible may enable the client terminals 102(1)-102(N) to more quickly receive notice of the anomaly and may more quickly reduce or eliminate any harmful effects of the anomaly. Waiting for the server 104 to complete a more detailed evaluation of the anomaly than the agent 106 already made before sending a report of the anomaly may incur a delay long enough for the client terminals 102(1)-102(N) to accept or pass information that would be identified as an anomaly using information in the report.

Once the server 104 reports the anomaly to the appropriate element or elements, then the server 104 may attempt 226 to address the anomaly. Addressing the anomaly generally includes mitigating or eliminating any potentially negative effects of the anomaly. The server 104 may automatically attempt to address the anomaly, or the server 104 may log some or all security problems for an administrator to examine and address at a later time.

If the server 104 does address the anomaly, e.g., develop a strategy to combat the effects of the anomaly on the VPN 114, then the server 104 can send 228 a remedy to the client terminals 102(1)-102(N) and/or the firewall 112.

Whether the server 104 addresses the anomaly or not, the server 104 may follow up 230 on the source of the anomaly, e.g., the intruder 122 or one of the client terminals 102(1)-102(N). Such follow up may include sending notice to the source that a security problem originated at the source's location, triggering a corporate security problem procedure, or performing another similar action.

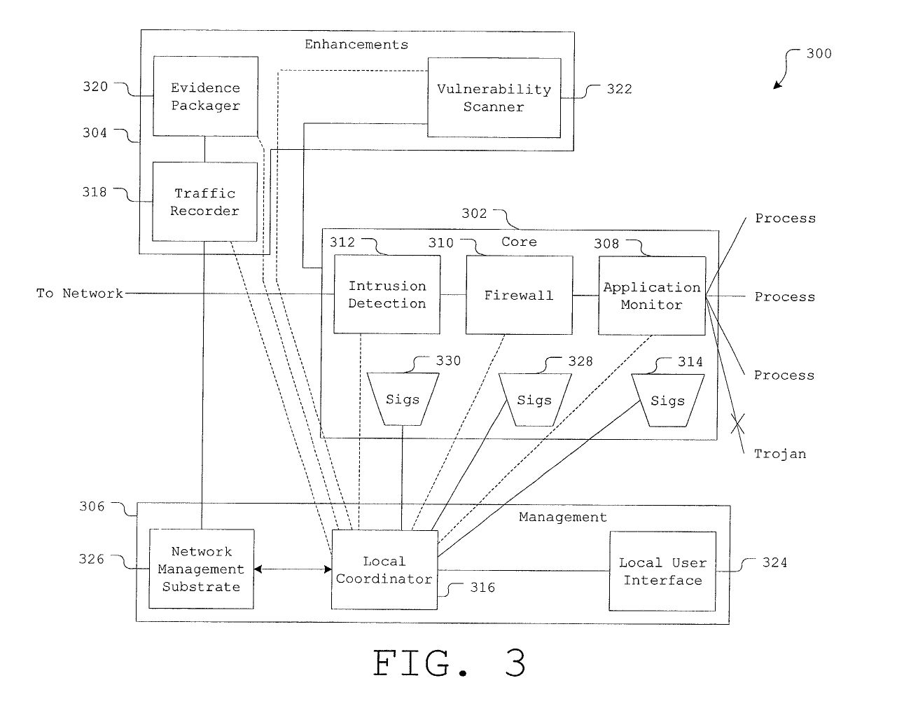

Referring to FIG. 3, a client setup 300 shows an example configuration of the client 102. Although the client setup 300 is described with reference to the elements included in the network configuration 100 of FIG. 1, this or a similar setup may be implemented in another, similar network configuration.

The client setup 300 includes a core mechanism 302, an enhancements mechanism 304, and a management mechanism 306. Each of these mechanisms 302, 304, and 306 is described below.

The core mechanism 302 can function as the agent 106, performing such actions as checking for and detecting known anomalies in information that arrives at the client 102 and reporting any detected anomalies. The core mechanism 302 includes an application monitor 308, a firewall 310, and an intrusion detection mechanism 312.

Information may enter the client setup 300 at the application monitor 308. The application monitor 308 can examine the information and determine if the information includes or indicates a known anomaly. In this examination and determination, the application monitor may consult information included in an application monitor collection of data 314 and/or a control program 316 included in the management mechanism 306.

The control program 316 is generally responsible for coordinating communications between the core mechanism 302 and the enhancements mechanism 304. For example, in examining information that arrives at the core mechanism 302, the application monitor 308 may desire information from the enhancements mechanism 304 regarding previously received information included in a traffic recorder 318, information regarding evidence of security problems included in an evidence packager 320, and/or information regarding vulnerabilities of the client setup 300, VPN 114, and/or other network configuration 100 elements included in a vulnerability scanner 322.

The control program 316 also may access a local user interface 324 and a network management substrate 326, both included in the management mechanism 306. The local user interface 324 can allow a user at the client 102 to interact with the client 102. The network management substrate 326 may receive and/or transmit information regarding the network or networks including the client 102 to the traffic recorder 318. Operations of the network management substrate 326 may also include communicating with the corporate server 116, installing and/or updating software included in the client setup 300, maintaining a record of resources such as software and applications included in the client setup 300, and performing other similar tasks.

Once the application monitor 308 examines information it receives, the application monitor 308 may send the information through the firewall 310 to the intrusion detection mechanism 312. The firewall 310 may consult information included in a firewall collection of data 328 and/or with the control program 316 in determining whether to pass the information through the firewall 310. The intrusion detection mechanism 312 can receive information, perform any additional intrusion detection operations on the information, such as making a record of the information before sending the information to the network 108, possibly consulting an intrusion detection collection of data 330 and/or the control program 316. Information can flow between the intrusion detection mechanism 312 and a network, such as the network 108 or the VPN 114.

Information can also flow out of the client setup 300 through the intrusion detection mechanism 312 and to a network.

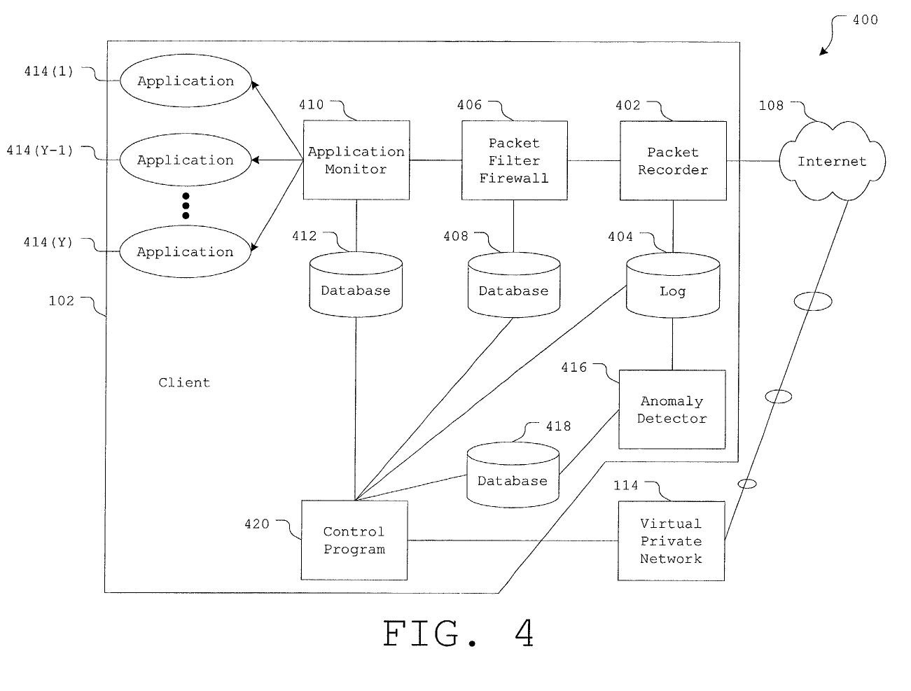

Referring to FIG. 4, a modified network configuration 400 shows a simplified example of how the client 102 may be set up. The modified network configuration 400 is described with reference to the elements included in the network configuration 100 of FIG. 1, but this or a similar setup may be implemented using other, similar elements.

The client 102 in the modified network configuration 400 includes elements similar to like-named elements included in the core mechanism 302 (see FIG. 3). The client 102 includes an intrusion detection mechanism 402 with an associated intrusion detection collection of data 404, a firewall 406 with an associated firewall collection of data 408, and an application monitor 410 with an associated application monitor collection of data 412.

The application monitor 410 may monitor applications 414(1)-414(Y) included in the client 102. (Y represents a whole number.) An application generally refers to one or more programs, functions, and/or other similar instructions capable of processing data and is typically implemented with software.

The client 102 also includes an anomaly detector 416 that may serve as the agent 106. In analyzing information for anomalies, the anomaly detector 416 may consult a collection of client data 418. The collection of client data 418 may include information that the anomaly detector 416 searches for in the information, such as names and addresses, attack patterns, etc.

If the anomaly detector 416 detects a possible anomaly, a control program 420 included in the client 102 can coordinate sending information about the possible anomaly to the server 104 via the VPN 114 and the network 108. The control program 420 can also coordinate proper dissemination of information sent to the client 102 via the VPN 114.

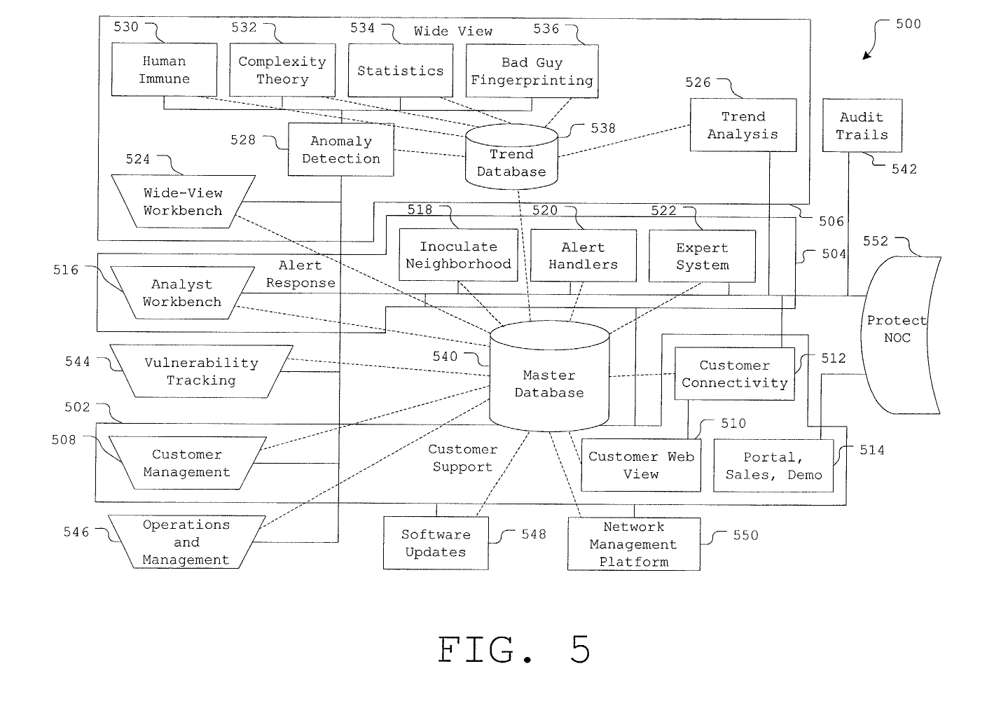

Referring to FIG. 5, a server setup 500 shows an example configuration of the server 104. Although the server setup 500 is described with reference to the elements included in the network configuration 100 of FIG. 1, this or a similar setup may be implemented in another, similar network configuration.

The server setup 500 includes a customer support mechanism 502, an alert response mechanism 504, and a wide view mechanism 506. Each of these mechanisms 502, 504, and 506 is described below.

The customer management mechanism 502 includes mechanisms that can provide information to and store information about the client terminals 102(1)-102(N). Such mechanisms may include a customer management mechanism 508 (e.g., for storing client information), a customer web view mechanism 510 (e.g., for storing web content to provide to the client terminals 102(1)-102(N)), a customer connectivity mechanism 512 (e.g., for managing client connections to the server 104), and a general mechanism 514 (e.g., for hosting a portal to the server 104, storing sales information, hosting demonstration web content, etc.).

The alert response mechanism 504 can include mechanisms able to generate and send appropriate intrusion updates to the client terminals 102(1)-102(N). The alert response mechanism 504 may include an analyst workbench 516 (e.g., for generating alerts), an inoculate neighborhood 518 (e.g., for storing information about programs to help detect changes in and security problems with the programs), alert handlers 520 (e.g., for sending alerts to the client terminals 102(1)-102(N)), and an expert system 522 (e.g., for collecting and using human knowledge in evaluating anomalies).

The wide view mechanism 506 can include mechanisms able to collect and maintain information regarding anomalies reported to the server 104 by the client terminals 102(1)-102(N) (and possibly from other sources included on the network 108). The wide view mechanism 506 may include a wide-view workbench 524 (e.g., for providing information about anomalies), a trend analysis mechanism 526, and an anomaly detection mechanism 528.

The anomaly detection mechanism 528 can help determine if an anomaly sent to the server 104 is an actual anomaly by consulting a human immune mechanism 530 (e.g., for collecting information on users), a complexity theory mechanism 532 (e.g., for storing and performing complex analysis of anomaly trends), a statistics mechanism 534 (e.g., for computing and storing records of anomalies), a fingerprinting mechanism 536 (e.g., for checking and storing names and addresses associated with security problems), and a collection of trend data 538 (e.g., for storing information calculated by the anomaly detection mechanism 528, the human immune mechanism 530, the complexity theory mechanism 532, the statistics mechanism 534, and the fingerprinting mechanism 536).

Other elements included in the server setup 500 may include an audit trails mechanism 542 (e.g., for providing a record of actions taken regarding an anomaly), a vulnerability tracking mechanism 544 (e.g., for providing information about susceptibility of the server 104, VPN 114, etc. to security attacks), an operations and management mechanism 546 (e.g., for providing operating and administrative information about the server 104), a software updates mechanism 548 (e.g., for providing software updates to the client terminals 102(1)-102(N)), a network management platform 550 (e.g., for providing information about the network 108, the VPN 114, and the corporate network 110), and a protection mechanism 552 (e.g., a firewall between the server 104 and the network 108).

A master collection of data 540 may collect and store information from elements included in the server setup 500. The master collection of data 540 may also serve as an intermediary for elements included in the server setup 500, providing information from one mechanism included in the server setup 500 to another mechanism. Information included in the master collection of data 540 may include information from audit trails, system logs, firewall logs, application logs, server logs, and other similar information sources.

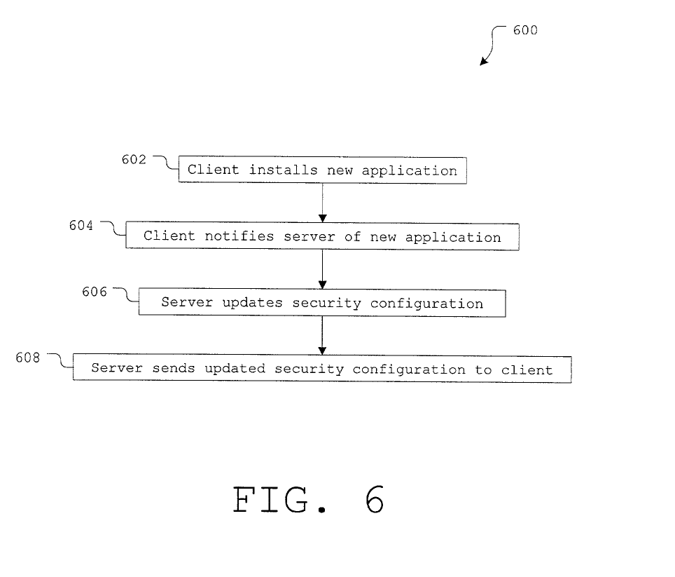

Referring to FIG. 6, an installation process 600 shows an example of how an application may be installed at the client 102. Although the installation process 600 is described with reference to the elements included in the network configuration 100 of FIG. 1, this or a similar process may be implemented in another, similar network configuration.

In the installation process 600, the client 102 installs 602 a new application. The client 102 can notify 604 the server 104 that it installed a new application via the VPN 114 and the corporate server 116. This information may help the server 104 in detecting actual anomalies. If the server 104 receives notice of a possible security problem from the client 102 without knowledge of a newly installed application, then the server 104 may erroneously conclude that the possible security problem poses an actual security threat. For example, if a packet destined for (or sent from) the newly installed application arrives at the client 102, the server 104 may deem it a security threat because the packet is addressed to what the server 104 determines to be a nonexistent destination (or source) at the client 102.

Receiving notice of the newly installed application, the server 104 can update 606 its security configuration to include knowledge of the newly installed application. This update may entail the server 104 updating the master collection of data 440 via the software updates mechanism 448 (see FIG. 4).

The server 104 may also send 608 an updated security configuration that accounts for the newly installed application to the client 102 (or all of the client terminals 102(1)-102(N)) via the VPN 114 and the corporate server 116. The server 104 may send the update directly to the agent 106 (or all of the agents 106(1)-106(N).) For example, the client 102 may examine different types of applications for certain anomalies in different ways, and the updated security configuration can inform the client 102 (or all of the client terminals 102(1)-102(N)) how to examine the newly installed application.

The techniques described here are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, and similar devices that each include a processor, a storage medium readable by the processor (including volatile and non-volatile memory and/or storage elements), at least one input device, and one or more output devices. Program code is applied to data entered using the input device to perform the functions described and to generate output information. The output information is applied to one or more output devices.

Each program may be implemented in a high level procedural or object oriented programming language to communicate with a machine system. However, the programs can be implemented in assembly or machine language, if desired. In any case, the language may be a compiled or interpreted language.

Each such program may be stored on a storage medium or device, e.g., compact disc read only memory (CD-ROM), hard disk, magnetic diskette, or similar medium or device, that is readable by a general or special purpose programmable machine for configuring and operating the machine when the storage medium or device is read by the computer to perform the procedures described in this document. The system may also be considered to be implemented as a machine-readable storage medium, configured with a program, where the storage medium so configured causes a machine to operate in a specific and predefined manner.

Other embodiments are within the scope of the following claims.

What is claimed is:

1. A method comprising:
detecting a possible security problem at a client location;
transmitting notice of the possible security problem across a network in real time to a home location remotely located from the client location;
determining at the home location an anomaly based on at least the possible security problem; and
transmitting notice of the anomaly in real time to the client location.

2. The method of claim 1 further comprising transmitting notice of the anomaly in real time to other client locations that may communicate with the home location over the network.

3. The method of claim 1 further comprising notifying a firewall located between the client location and the home location about the anomaly.

4. The method of claim 1 further comprising inspecting a packet that arrives at the client location to detect the possible security problem.

5. The method of claim 1 in which the network includes a virtual private network.

6. The method of claim 1 in which the anomaly includes unauthorized access to the network.

7. The method of claim 1 in which the anomaly includes unauthorized access of a resource accessible through the network.

8. The method of claim 1 in which the anomaly includes unauthorized use of resources available through the network.

9. An article comprising:
a machine-readable medium which contains machine-executable instructions, the instructions causing a machine to:
detect a possible security problem at a client location;
transmit notice of the possible security problem across a network in real time to a home location remotely located from the client location;
determine at the home location an anomaly based on at least the possible security problem; and
transmit notice of the anomaly in real time to the client location.

10. The article of claim 9 further causing a machine to transmit notice of the anomaly in real time to other client locations that may communicate with the home location over the network

11. The article of claim 9 further causing a machine to notify a firewall located between the client location and the home location about the anomaly.

12. The article of claim 9 further causing a machine to inspect a packet that arrives at the client location to detect the possible security problem.

13. The article of claim 9 in which the network includes a virtual private network.

14. The article of claim 9 in which the anomaly includes unauthorized access to the network.

15. The article of claim 9 in which the anomaly includes unauthorized access of a resource accessible through the network.

16. The article of claim 9 in which the anomaly includes unauthorized use of resources available through the network.

17. A method comprising:
at a home location in a network, receiving from a remote client location an indication of a possible security problem at the client; and
determining in real time at the home location an existence of an anomaly based on at least the indication of the possible security problem.

18. The method of claim 17 further comprising transmitting notice of the existence of the anomaly in real time from the home location to the remote client location.

19. The method of claim 17 further comprising notice of the existence of the anomaly in real time from the home location to other remote client locations that many communicate with the home location over the network.

20. The method of claim 17 further comprising notifying, from the home location, a firewall located between the remote client location and the home location about the anomaly.

21. The method of claim 17 further comprising transmitting information from the home location to the remote client location to help the remote client location identify possible security problems.

22. The method of claim 17 further comprising determining the existence of the anomaly based on at least information regarding previous anomalies.

23. A method comprising:
detecting a possible security problem at a client location;
transmitting notice of the possible security problem across a network in real time to a home location remotely located from the client location; and
receiving in real time at the client location a notice from the home location indicating an existence of an anomaly based on at least the possible security problem.

24. The method of claim 23 further comprising inspecting a packet that arrives at the client location to detect the possible security problem.

25. The method of claim 23 further comprising receiving in real time at the client location a notice from the home location indicating an existence of a possible security problem detected by another client location that can communicate with the home location over the network.

26. An apparatus comprising:
a client terminal;
a first mechanism accessible by the client terminal and configured to detect a possible security problem at the client terminal;
a second mechanism accessible by the client terminal and configured to transmit notice of the possible security problem across a network in real time to a server remotely located from the client terminal; and
a third mechanism accessible by the client terminal and configured to receive updates from the server in real time regarding security problems that the first mechanism may use in detecting possible security problems.

27. The apparatus of claim 26 in which the first mechanism is also configured to monitor packets that arrive at the client terminal for the possible security problem.

28. An apparatus comprising:
a server;
a first mechanism accessible by the server and configured to determine an anomaly based on at least information from a client regarding a possible security problem; and
a second mechanism accessible by the server and configured to transmit notice of the anomaly in real time over a network to the client and to other client locations that may communicate with the server over the network.

29. The apparatus of claim 28 in which the first mechanism is also configured to determine the anomaly based on at least information regarding previously determined anomalies.

30. A system comprising:
a client terminal;
a server;
a first client mechanism accessible by the client terminal and configured to detect a possible security problem at the client terminal;
a second client mechanism accessible by the client terminal and configured to transmit notice of the possible security problem across a network in real time to a server remotely located from the client terminal;
a third client mechanism accessible by the client terminal and configured to receive updates from the server in real time regarding security problems that the first client mechanism may use in detecting possible security problems;
a first server mechanism accessible by the server and configured to determine an anomaly based on at least information from a client regarding a possible security problem; and
a second server mechanism accessible by the server and configured to transmit notice of the anomaly in real time over the network to the client terminal.

31. The system of claim 30 in which the first client mechanism is also configured to monitor packets that arrive at the client terminal for the possible security problem.

32. The system of claim 30 in which the first server mechanism is also configured to determine the anomaly based on at least information regarding previously determined anomalies.

33. The system of claim 30 in which the second server mechanism is also configured to transmit notice of the anomaly in real time to other client locations that may communicate with the server over the network.

34. The system of claim 30 further comprising a firewall located between the client terminal and the server and configured to act as an intermediary for information flowing between the client terminal and the server.

35. The system of claim 34 in which the firewall includes a corporate server.

36. A method comprising:
processing information relating to possible security problems associated with a private network at a home location to determine a security problem; and
modifying a monitoring agent included at each one of multiple clients to reflect the security problem, each one of the multiple clients capable of communicating the information to the home location.

37. The method of claim 36 further comprising performing the modifying in real time.

38. The method of claim 36 in which the multiple clients can communicate the information in real time.
